(19) United States
(12) Patent Application Publication
(10) Pub. No.: US 2015/0066554 A1
(43) Pub. Date: Mar. 5, 2015

(54) OPTIMIZING ORGANIZATION AND MANAGEMENT OF TEAMS

(71) Applicant: Brigham Young University, Provo, UT (US)

(72) Inventors: Walter Edward Red, Provo, UT (US); Brett Stone, Lehi, UT (US)

(21) Appl. No.: 14/477,665

(22) Filed: Sep. 4, 2014

Related U.S. Application Data
(60) Provisional application No. 61/873,760, filed on Sep. 4, 2013.

(51) Int. Cl. G06Q 10/06

(52) U.S. Cl. CPC G06Q 10/063112
USPC 705/7.14

(57) ABSTRACT

An apparatus, method, and computer program product are disclosed for optimizing organization and management of teams. A data module collects activity data for a user, which is associated with the user's operation of a computer application. A profile module updates a profile for the user in response to the activity data, and a team module selects the user to be a member of a team based on the user's profile. A team includes a plurality of users combined to perform a task.

### CROSS-REFERENCES TO RELATED APPLICATIONS

This application claims the benefit of U.S. Provisional Patent Application No. 61/873,760 entitled “Management of Multi-User CAx Product Development Teams” and filed on Sep. 4, 2013, for Walter Edward Red, which is incorporated herein by reference.

### FIELD

This invention relates to team management and more particularly relates to optimizing team member selection based on experiential data.

### BACKGROUND

Teams may be an essential component of various organizations in order to complete various projects or tasks. An organization may comprise a number of employed persons who each have different backgrounds, experiences, capabilities, etc. In order to complete a task for the organization, a team manager may try to assemble a team of persons who are the most qualified to work together to complete the task as efficiently and effectively as possible. It may be difficult, however, for a team leader to determine the best combination of persons to complete a particular task, especially in situations where the team leader has not worked with, or is not otherwise familiar with, many of the people within the organization.

### SUMMARY

An apparatus for optimizing organization and management of teams is disclosed. A method and computer program product also perform the functions of the apparatus. In one embodiment, the apparatus includes a data module that collects activity data for a user. In certain embodiments, the activity data is associated with the user's operation of a computer application. In a further embodiment, the apparatus includes a profile module that updates a profile for the user in response to the activity data. In certain embodiments, the apparatus includes a team module that selects the user to be a member of a team based on the user's profile. In some embodiments, the team includes a plurality of users combined to perform a task.

In one embodiment, the apparatus includes a monitor module that determines the user is actively using the computer application. In some embodiments, the data module collects activity data in response to the monitor module determining the computer application is actively being used. In certain embodiments, the monitor module determines the user is actively using the computer application by detecting user input received in an active window for the computer application.

In one embodiment, the team module selects the user for the team in response to one or more characteristics of the user's profile corresponding to one or more characteristics of the task to be performed by the team. In a further embodiment, the team module selects the user for the team based on output received as a function of a search algorithm. In some embodiments, the search algorithm determines a fitness score for a combination of users that includes the user. The fitness score may describe a likelihood of success for the task by the combination of users. In certain embodiments, the combination of users that have the highest fitness score for the task is selected.

In one embodiment, the team module recommends one or more users for the team in response to input received from a team manager. The input may comprise one or more user characteristics associated with the task. In a further embodiment, the apparatus includes a search module that searches one or more user profiles in response to search criteria. The search criteria may comprise a plurality of search filters corresponding to the characteristics of a user profile.

In one embodiment, the computer application comprises a multi-user computer application such that multiple users may use the computer program simultaneously. The data module may collect activity data separately for each user of the multi-user computer application. In some embodiments, the profile for the user comprises data collected from one or more of surveys and aptitude tests. In one embodiment, the profile for the user comprises data received from the user, such as data comprising preference data related to the user's preferences for one or more tasks.

In one embodiment, the profile for the user comprises a plurality of characteristics associated with the user, such as computer application activity data, demographic data, social data, employment data, education data, schedule data, location data, project history data, and security clearance data. In certain embodiments, the activity data includes a total time that the computer application is used, one or more features of the computer application that are used, and/or a total time that a feature of the computer application is used.

A method, in one embodiment, includes collecting activity data for a user. In some embodiments, the activity data is associated with the user's operation of a computer application. In certain embodiments, the method includes updating a profile for the user in response to the activity data. In some embodiments, the method includes selecting the user to be a member of a team based on the user's profile. In a further embodiment, the team includes a plurality of users combined to perform a task.

In one embodiment, the method includes determining the user is actively using the computer application. In some embodiments, activity data is collected in response to determining the computer application is actively being used. In a further embodiment, determining the user is actively using the computer application comprises detecting user input received in an active window for the computer application. In some embodiments, the user is selected for the team in response to one or more characteristics of the user's profile corresponding to one or more characteristics of the task to be performed by the team.

In a further embodiment, the user is selected for the team based on output received as a function of a search algorithm, which may determine a fitness score for a combination of users that includes the user. In certain embodiments, the fitness score describes a likelihood of success for the task by the combination of users. In one embodiment, the combination of users that have the highest fitness score for the task is selected to perform the task.

In one embodiment, the method includes recommending one or more users for the team in response to input received from a team manager. In certain embodiments, the input includes one or more user characteristics associated with the task. In some embodiments, the computer application comprises a multi-user computer application such that multiple users may use the computer program simultaneously. In certain embodiments, the activity data for each user of the multi-user computer application is collected separately.

A computer program product, in one embodiment, includes a computer readable storage medium having program code embodied therein. In one embodiment, the program code is readable/executable by a processor for collecting activity data for a user. In some embodiments, the activity data is associated with the user's operation of a computer application. In some embodiments, the program code is readable/executable by a processor for updating a profile for the user in response to the activity data. In a further embodiment, the program code is readable/executable by a processor for selecting the user to be a member of a team based on the user's profile. In one embodiment, the team comprises a plurality of users combined to perform a task.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for optimizing organization and management of teams;

FIG. 2 is a schematic block diagram illustrating one embodiment of a module for optimizing organization and management of teams;

FIG. 3 is a schematic block diagram illustrating another embodiment of a module for optimizing organization and management of teams;

FIG. 4 is a schematic block diagram illustrating one embodiment of a system for optimizing organization and management of teams;

FIG. 5 is a schematic flow chart diagram illustrating one embodiment of a method for optimizing organization and management of teams; and

FIG. 6 is a schematic flow chart diagram illustrating another embodiment of a method for optimizing organization and management of teams.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing.

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

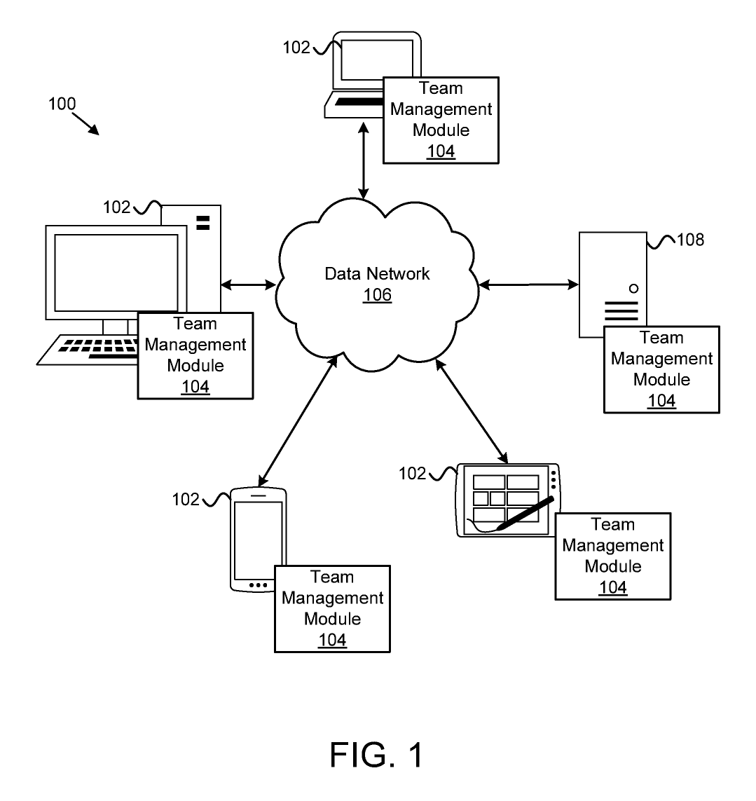

FIG. 1 depicts one embodiment of a system 100 for optimizing organization and management of teams. In one embodiment, the system 100 includes information handling devices 102, team management modules 104, data networks 106, and servers 108, which are described below in more detail. While a specific number of elements 102-108 of the system 100 are depicted in FIG. 1, any number of elements 102-108 may be included in the system 100 for on-screen keyboard management.

In one embodiment, the information handling devices 102 include electronic computing devices, such as desktop computers, laptop computers, tablet computers, smart televisions, smart phones, servers, and/or the like. In one embodiment, the team management module 104 is configured to collect activity data for a user. In certain embodiments, the activity data is associated with the user's operation of a computer application. In some embodiments, the team management module 104 updates a profile for a user in response to the activity data, and selects the user to be a member of team based on the user's profile. In certain embodiments, at least a portion of the team management module 104 is located on an information handling device 102. In a further embodiment, at least a portion of the team management module 104 is located on a server 108.

The data network 106, in one embodiment, comprises a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, and/or the like. The data network 106 may include a wide area network (WAN), a storage area network (SAN), a local area network (LAN), an optical fiber network, the Internet, an internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, random access memory (RAM), or the like.

In one embodiment, the system 100 includes a server 108. The server 108 may be embodied as a desktop computer, a laptop computer, a mainframe, a cloud server, a virtual machine, or the like. In some embodiments, the information handling devices 102 are communicatively coupled to the server 108 through the data network 106. The server 108 may include data accessible by an information handling device 102 through the data network 106, such as computer applications, databases, or the like. For example, the server 108 may run an instance of a multi-user computer-aided drafting (CAD) program that is accessible to a plurality of information handling devices 102 through the data network 106, and may store data associated with the use of the CAD program in a database operably connected to the server 108. The server 108, in some embodiments, may be configured as a file server, media server, email server, game server, and/or the like.

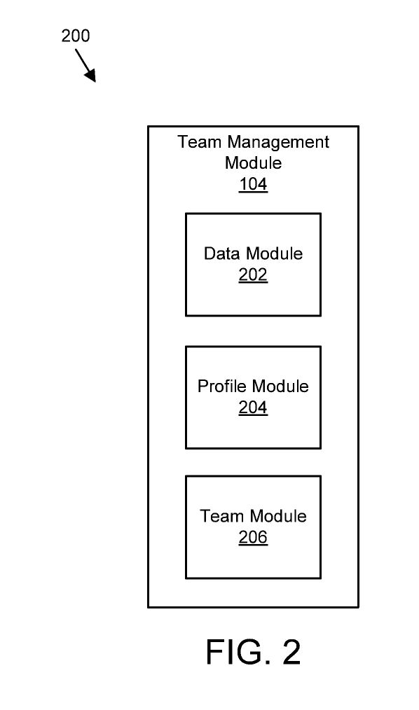

FIG. 2 is a schematic block diagram illustrating one embodiment of a module 200 for optimizing organization and management of teams. In one embodiment, the module 200 includes an embodiment of a team management module 104. The team management module 104, in certain embodiments, includes a data module 202, a profile module 204, and a team module 206, which are described in more detail below.

In one embodiment, the data module 202 is configured to collect activity data for a user. In certain embodiments, the activity data is associated with the user's operation of a computer application, a computer program, a computer program product, a software application, and/or the like. In some embodiments, the computer application comprises a single-user or multi-user computer program. As used herein, a single-user computer application refers to a computer program that may be usable only by one person at a time. A multi-user computer application, as used herein, refers to a computer program that allows multiple users to access the computer program at the same time. Examples of computer applications, both single- and multi-user, may include office suite applications (e.g., word processing, spreadsheet, and/or presentation programs), computer-aided applications (e.g., computer aided design, computer-aided manufacturing, computer-aided engineering, and/or the like), scheduling programs, collaboration tools, planning programs, and/or the like.

Where a multi-user computer program is being used, the computer program may be located on a central server 108, such as a cloud server or a centralized server on an intranet. Clients may connect to the central server 108 via a network 106 in a typical client-server architecture model. In this manner, a plurality of clients, using various information handling devices 102 and located at different locations, may simultaneously access the computer program and collaboratively work together on a task, project, model, and/or the like. In such an embodiment, at least a portion of the team management module 104 may be located on the central server 108. In a single-user architecture, the team management module 104 may be located on an information handling device 104 associated with a user.

Regardless of whether the computer program is a single- or multi-user program, the data module 202 may collect activity data related to the user's activities while using the program. For example, the data module 202 may track and collect data for a total time that a user uses the computer program. In some embodiments, the data module 202 collects data related to one or more features, functions, modules, and/or the like, of the computer application that the user uses. For example, the data module 202 may determine that a user used a “sheet metal” modeling module of a computer-aided manufacturing program. In a further embodiment, the data module 202 collects data related to a total time that a feature of the computer application is used. Thus, the data module 202 may determine that the user used the “sheet metal” modeling module for 3.5 hours. In one embodiment, the data module 202 collects quality-related data associated with the user's use of the computer application. The quality-related data may be based on industry standards, an organization's best practices, and/or the like.

The data module 202, in response to collecting the data for the user's use of the computer application, stores the data in a database. In certain embodiments, the data module 202 is located on an information handling device 102 of a user and sends collected data to a database located on a server 108 through the data network 106. In some embodiments, the data module 202 collects data in real-time and stores data in the database in real-time. In this manner, the data in the database is kept up-to-date such that parties interested in the data receive recent and accurate data. In some embodiments, the database comprises an experiential database. An experiential database, as used herein, is a database that stores data related to various characteristics describing a user's capabilities and/or experiences. The experiential database may organize the data into one or more profiles for a user, as described below, which may be viewable, searchable, writable, readable, and/or the like.

In one embodiment, the data module 202 may collect data for users of the computer program, which may include employees, contractors, staff members, interns, managers, suppliers, vendors, external collaborators, and/or the like. In some embodiments, the data module 202 may collect data related to an organization, such as which computer applications are being used, how many total hours users have spent on projects, tasks, and/or the like and the total hours spent by users using various computer applications, and/or the like. In certain embodiments, managers, supervisors, employees, and other users may have access to the data in the database. In certain embodiment, the data is associated with a security clearance such that data may only be accessed by users that have a corresponding, or higher, security clearance.

In one embodiment, the profile module 204 is configured to update a profile for the user in response to the activity data. As used herein, a profile is a collection of data associated with a specific user. The profile may have an associated visual display that is presented on an interface when a profile for a user is requested. The profile module 204 may maintain a plurality of profiles on the server 108, with each user having an associated profile. For example, in an organization, each employee, staff member, contractor, vendor, supplier, manager, director, supervisor, intern, and/or the like may have a profile.

A user's profile, in certain embodiments, includes various data describing the user, such as computer application activity data, demographic data, social data, employment data, education data, schedule data, location data, project history data, security clearance data, work-quality data, and/or the like. The user's profile may also include one or more images associated with the user. For example, a user's profile, as presented on an interface, may include an image of the user, basic personal data (name, phone number, etc.), computer application activity data (e.g., programs the user has used, features the user is familiar with, the time spent using an application or features of the application, etc.), social media information (such as links to a Facebook or Twitter page), the user's education background (e.g., colleges attended, degrees and/or certifications earned, etc.), the user's upcoming schedule, projects the user has worked on for the company, other users that the user has worked together with, languages that the user speaks, security clearances, if any, that the user may have, where the user is located, including time zone information, and/or the like. In this manner, a manager, supervisor, or team leader may be able to quickly learn about various people within an organization to better manage who to assign projects to, who is available to work on different tasks, and/or the like.

Thus, in certain embodiments, the profile module 204 updates a user's profile in response to receiving new data for a user's profile. In one embodiment, the data module 202 sends new computer application activity data for a user to the profile module 204, which updates the user's profile with the new data. For example, if the data module 202 determines that the user used a CAD program for 4.23 hours, and, in particular, used a 3D modeling tool of the CAD program for 3.13 hours, the profile module 204 may update the user's profile to reflect the activity data, including the computer program that the user used, the amount of time the user used the program, and the amount of time that the user used features of the program, e.g., the 3D modeling tool feature. In certain embodiments, the profile module 204 updates the user's profile in real time as data is received from the data module 202, which provides up-to-date data for parties viewing the user's profile.

In some embodiments, the profile module 204 updates a user's profile in response to data received from surveys, polls, quizzes, tests (e.g., aptitude tests, ethics tests, or the like), training courses, certifications, and/or the like. For example, other users who worked on a project with the user, such as peers, managers, subordinates, or the like, may evaluate the user by filling-out surveys regarding the user's performance as a member of the team, the user's capabilities, the user's ease to work with, and/or other qualitative measurements, which the profile module 204 may add to the user's profile. In certain embodiments, the user may submit a self-evaluation form before, during, or after working on a project, which may become part of the user's profile. In another example, the profile module 204 may update the user's profile in response to receiving data regarding the user's performance on aptitude tests, certification exams, ethics quizzes, and/or the like, which may be administered by the user's employee or a third party test administrator.

In one embodiment, the profile module 204 updates the user's profile in response to receiving input from the user, such as notes, comments, suggestions, feedback, and/or the like that are associated with the user's own profile. For example, a user may specify types of projects that she would prefer to work on, people who the user prefers to work with, and/or any other information that may not be measurable, quantifiable, or otherwise received without the user's input.

In one embodiment, the team module 206 selects the user to be a member of a team based on the user's profile. As used herein, the team comprises a plurality of users combined to perform a task. The team may comprise users from various backgrounds, industries, departments, cultures, and/or the like. For example, as described below in more detail, the team module 206 may select users for a product development team from the engineering department, the quality control department, the marketing department, the manufacturing department, and/or the like. Thus, an optimized team may be organized in such a way as to blend members with the appropriate capabilities for the task, project, components, processes, and/or the like.

The team module 206 may select users that are located at different locations around the world. Such a team may comprise a virtual team where users collaborate and work together using telecommunication technologies, such as email, instant message, cell phones, the Internet, text messages, social media, and/or the like. In such an embodiment, the computer application may comprise a multi-user application located on a cloud server such that the dispersed team members may simultaneously collaborate and work together from their various locations using the same computer application. In some embodiments, the team members may be located at the same location, such as a team of users that work together in the same physical location. The team module 206 may consider the location of the user, as specified in the user's profile, as one of various factors when determine whether to assign the user to a team.

In some embodiments, the task comprises a project associated with an organization. For example, the task may comprise developing a new product line for the organization. In another example, the task may comprise developing a new marketing campaign for the organization. Other tasks may include budget planning and analysis, presentation creation, computer-aided design projects, programming projects, and/or the like. In order to complete the various tasks, the team module 206 may select any number of users that have various backgrounds, experiences, and/or the like, such that the team members cross disciplines, functions, departments, suppliers, vendors, and geographical locations.

Regardless the task, the team module 206 may select a user to be a member of the team based on the user's profile. In one embodiment, the team module 206 selects a user for the team in response to one or more characteristics of the user's profile corresponding to one or more characteristics of the task to be performed by the team. For example, the task may include the development of a new product being designed in a CAD application using functions “A” and “B” of the CAD application. If the user has a history of using the CAD application, and, in particular functions “A” and “B” of the CAD application, as determined by the data module 202, the team module 206 may select to the user for the team.

In some embodiments, the team module 206 selects a user for the team based on output received as a function of a search algorithm. In one embodiment, the search algorithm comprises a genetic algorithm. As used herein, a genetic algorithm may generate solutions to optimization problems using techniques inspired by natural evolution, such as inheritance, mutation, selection, and crossover. In some embodiments, a search algorithm, such as a genetic algorithm, determines a fitness score for a combination of users. A fitness score may be based on a fitness function and may describe a likelihood of success for the task by the combination of users.

The team module 206 may generate a search algorithm based on one or more characteristics of a plurality of users. The characteristics may be selected from the users' profiles. The characteristics of the task to be completed may also be incorporated into the search algorithm. The fitness function may determine the effectiveness of the selected group of users to complete the task. For example, if a task requires one or more team members have a particular language skill, such as Spanish, the fitness function may enforce this requirement by generating higher fitness scores to combinations of users having a Spanish-language speaker than combinations of users that do not.

The team module 206, in order to introduce variability (e.g., mutations for a genetic algorithm) into the search algorithm, may alter one or more characteristics, users, project characteristics, and/or the like and determine a new fitness score for the modified search algorithm. For example, the team module 206 may iteratively substitute different users, including their characteristics, into the search algorithm to determine the most effective team for the project. The team module 206, after determining fitness scores for a plurality of different combinations of users, user characteristics, and/or project characteristics, may select the combination of users that has the highest fitness score for the task.

In certain embodiments, the team module 206 recommends one or more team members to a user, such as a project manager, in response to input received from the user. For example, a project manager may specify that he needs three team members that each have at least 200 hours working with a particular function of a specific CAD application. The project manager may specify other desired characteristics, such as that the users speak Japanese, are located locally, and have a Master's degree in engineering. In response to the input received from the project manager, the team module 206 may search the plurality of profiles within the database and return a list of profiles that meet one or more of the project manager's desired characteristics.

In certain embodiments, the team module 206 recommends users based on input received from the users, such as the types of projects the users want to work on, the people the user prefers to work with, and/or the like. Thus, in the previous example, even if a user does not have Japanese language skills, the team module 206 may recommend the user because the user may have specified in their profile that they prefer to work with the project manager overseeing the project.

In certain embodiments, the team module 206 recommends trainings, certification programs, and/or the like, to a user based on one or more preferences provided by the user. For example, the user may specify that he is interested in working with a particular CAD program, but may lack the skills or experience to be selected for projects that use the CAD program. Thus, based on the user's preference to work on a project using the CAD program, the team module 206 may recommend the user take a particular training course on the CAD program in order to gain additional skills and experience such the user may be selected to work on teams for future projects that use the CAD program. In some embodiments, the team module 206 may select the user for an “on the job” training program as part of a project that corresponds to the user's preferences. The team module 206 may notify a team leader/manager as to the user's preferences, who may select the user for an “on the job” training project based on the user's interests.

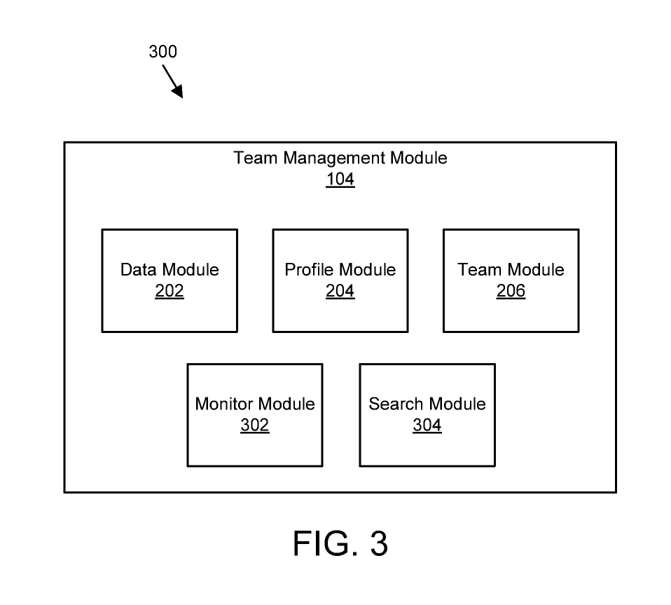

FIG. 3 is a schematic block diagram illustrating one embodiment of a module 300 for optimizing organization and management of teams. In one embodiment, the module 300 includes an embodiment of a team management module 104. The team management module 104, in certain embodiments, includes a data module 202, a profile module 204, and a team module 206, which may be substantially similar to the data module 202, the profile module 204, and the team module 206 described above with reference to FIG. 2. In some embodiments, the team management module 104 includes a monitor module 302 and a search module 304, which are described in more detail below.

In one embodiment, the monitor module 302 is configured to determine the user is actively using the computer application. In certain embodiments, the user is actively using the computer application during a period of time that the user is interacting with the computer application. The data module 202, in some embodiments, collects activity data for the user in response to the monitor module 302 determining that the user is actively using the computer application.

In one embodiment, the monitor module 302, in order to determine that the user is actively using the computer application, detects user input received in an active window for the computer application. For example, the monitor module 302 may detect mouse movements, mouse clicks, and/or keyboard input while a window for the computer program is the active window. In some embodiments comprising a touch-enabled display, the monitor module 302 detects touch input from a finger and/or a stylus, such as finger swipes, finger taps, and/or the like. Other input methods, such as sensor input, camera input, microphone input, and/or the like may be detected by the monitor module 302.

The active window for the computer program, as used herein, comprises a graphical window for the computer program that currently has focus to receive input. Thus, the monitor module 302, in certain embodiments, detects user input in response to a window for the computer program having focus. In this manner, the monitor module 302 tracks user input, and the data module 202 collects activity data when the user is actively using the application. For example, the user may execute a computer-aided design program such that a window for the computer-aided design program has focus to receive input from the user; however, if the user never interacts with the active window, such as by clicking with a mouse or typing keys on a keyboard, the monitor module 302 may determine that the user is not actively using the application, and the data module 202 may not collect activity data (e.g., the data module 202 may not determine how long the user is using the application because the user may not actively be using the application).

In one embodiment, the search module 304 is configured to search one or more user profiles in response to search criteria. In certain embodiments, the search module 304 may receive search criteria from user input. The search criteria may comprise one or more keywords, ranges of numbers, Boolean values, specific values, and/or the like, and the search module 304 may perform a search of a plurality of user profiles to find profiles containing one or more of the keywords. In certain embodiments, the search module 304 performs a natural language search based on the search criteria.

The search module 304, in certain embodiments, may employ one or more search filters based on the search criteria. For example, the search module 304 may provide a list of one or more characteristics that correspond to characteristics of a user's profile. For example, the search module 304 may provide a list comprising various computer application types and their corresponding features that a team manager may need in a team member. Other filters may include different educational backgrounds, language skills, locations, and/or the like. The team manager may select the characteristics that she desires for her team and the search module 304 may search the various profiles based on the team manager's input.

In certain embodiments, the search module 304 provides predefined search filters for predetermined tasks, such as developing a new software product using a particular language, creating a new presentation, creating a particular model in a computer-aided application, and/or the like. In some embodiments, the search module 304 saves a user's custom search filter such that the user may execute the search filter for a different search.

In some embodiments, the search module 304 determines the capabilities of a company, or an entity, agency, or organization within the company, based on a search of a plurality of the profiles associated with users within the company. For example, a manager may perform a search to determine which department within the company has the most experience with a CAD program, or a function within the CAD program. In response to the search criteria, the search module 304 may determine which users belong to which departments, and then further determine the amount of time that users within each department have used the CAD program or function.

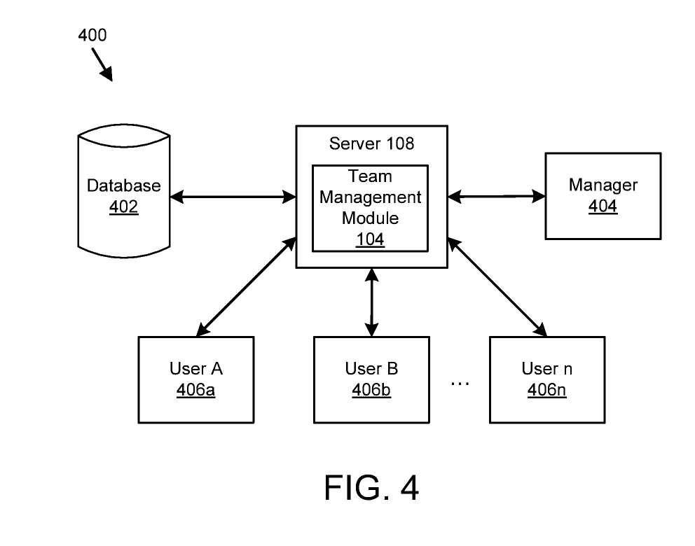

FIG. 4 depicts one embodiment of a system 400 for optimizing organization and management of teams. In one embodiment, the system includes a server 108 that includes an instance of team management module 104. In some embodiments, the system 400 includes a device 404 operated by a team manager and one or more user devices 406a-n, which may include users such as employees, contractors, staff, and/or the like. In a further embodiment, the server 108 is communicatively coupled to a database 402. In some embodiments, the server 108 and the database 402 comprise a cloud storage system such that the manager 404 and the users 406a-n are in communication with the server 108 via a data network.

In either a single-user or multi-user scenario, a data module 202 collects activity data for a computer application from the one or more users 406a-n in response to a monitor module 302 determining that a user 406a-n is actively using the computer application. The data module 202, during or after collection of the activity data, stores the activity data in the database 402. Thus, the database 402 may be considered an experiential database that stores data associated with a user's operation of the computer program. In some embodiments, a profile module 204 updates a user profile associated with a user 406a-n by incorporating the collected activity data into the profile. The profile module 204 may store a user's profile in the database 402, and may associate other data with a user 406a-n, such as the user's educational background, language proficiencies, hobbies, previous projects completed, and/or the like.

In a multi-user scenario, each user 406a-n may work simultaneously with a computer program on the server 108. In such an embodiment, the data module 202 may collect data regarding the users 406a-n activities within the computer application, how long the users 406a-n worked together, which users 406a-n worked together, and/or the like. In this manner, the team module 206 may select and/or recommend users 406a-n that work well together, e.g., users 406a-n that work together efficiently, productively, or the like. In a single-user scenario, each user 406a-n may work independently while the data module 202 collects their activity data and sends the data to the database 402 via the server 108. In either multi- or single-user mode, a user's 406a-n experience with a computer application is monitored and data is collected such that team managers, or other interested parties, may determine the user's 406a-n proficiency with the computer application.

A team module 206 may select a plurality of users 406a-n to work together on a team to complete a task in response to the manager 404 specifying one or more characteristics of the task, one or more characteristics of a user 406a-n, and/or the like. For example, the manager 404 may specify that he needs two team members who have 20 or more hours of experience in a computer-aided manufacturing program. The team module 206 may recommend one or more users 406a-n to the team manager 404 based on the manager's input and the users' profile data, e.g., such as if the manager's specifications match a user's profile characteristics. In certain embodiments, the team module 206 employs a search algorithm to determine the best fit of team members to complete a given task based on the characteristics of the task and the characteristics of the users' profiles.

The team module 206 may also select one or more team members based on criteria implied in response to a team leader's input. For example, if a team manager 404 specifies that the client for a project is a defense contractor with specific rules regarding who may work on the project, i.e., specific security clearance requirements, the team module 206 may recommend users 406a-n that have the particular security clearance. In some embodiments, the team module 206 suggests one or more input criteria as part of a team leader's 404 requirements. For example, if most managers from a department within a company usually seek users with a particular security clearance to work on projects within the department, and the team leader neglects to specify the security clearance information as a required criteria for the team working on a similar project, the team module 206 may suggest that the manager include such criteria. Similarly, in a different example, if a manager specifies that the client for a certain project is a medical device company, the team module 206 may suggest that the team manager include a criteria that at least one member of the team have a predetermined amount of experience in the medical field.

In certain embodiments, the manager 404 may specify which activity data should be collected by the data module 202. For example, the manager 404 may specify to only collect data regarding use of a CAM application and not a CAD application. In some embodiments, in order to access the data of the database 402, the manager 404 must have a security clearance that is higher than, or equal to, the security level of the data. For example, if a user's profile data has a security level of “top secret,” but the manager 404 only has a security level of “secret,” the data module 202 may not allow the manager 404 to access the data.

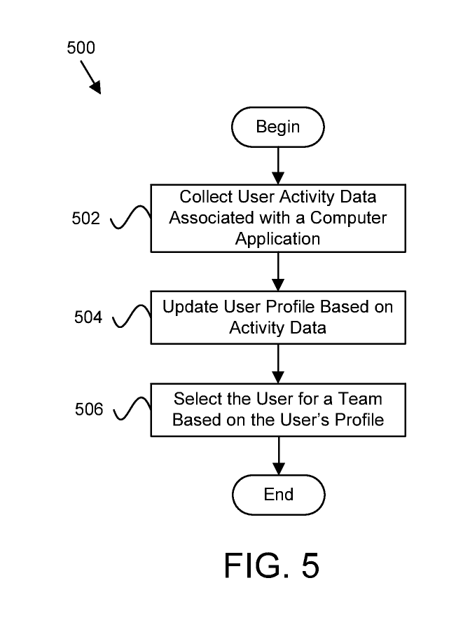

FIG. 5 is a schematic flow chart diagram illustrating one embodiment of a method 500 for optimizing organization and management of teams. In one embodiment, the method 500 begins and a data module 202 collects 502 user activity data associated with a computer application. In certain embodiments, the activity data is associated with the user's operation of a computer application. In a further embodiment, the profile module 204 updates 504 a user profile based on the collected activity data. In some embodiments, the team module 206 selects 506 a user to be a member of a team based on the user's profile. The team, in certain embodiments, comprises a plurality of users combined to work together to complete a task, and the method 500 ends.

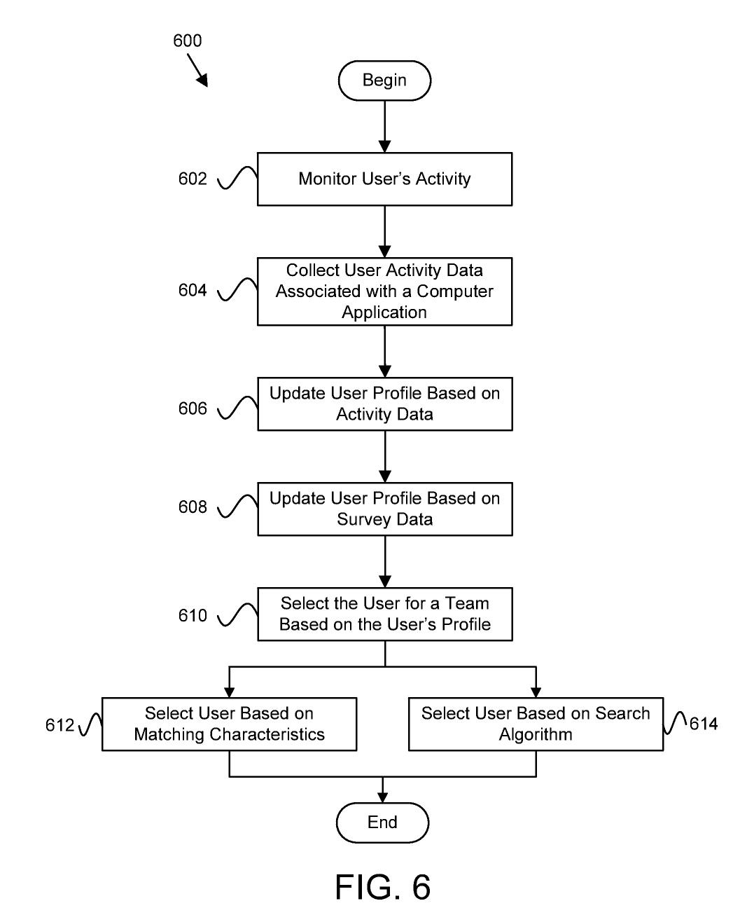

FIG. 6 is a schematic flow chart diagram illustrating a further embodiment of a method 600 for optimizing organization and management of teams. In one embodiment, the method 600 begins and a monitor module 302 monitors 602 a user's activity in order to determine whether the user is actively using the computer application. In order to determine whether the user is actively using the computer program, the monitor module 302 detects user input received in an active window for the computer application. In response to determining that the user is actively using the computer application, the data module 202 collects 604 user activity data associated with the user's operation of the computer application.

The profile module 204 updates 606 a user's profile in response to the collected activity data. In some embodiments, the profile module 204 updates 608 a user's profile in response to the data module 202 collecting data from surveys, aptitude tests, and/or the like, associated with the user. In some embodiments, a team module 206 selects 610 a user for a team based on the user's profile. In certain embodiments, the team module 206 selects 612 a user for the team in response to one or more characteristics of the user's profile corresponding to one or more characteristics of the task to be performed by the team. In a further embodiment, the team module 206 selects 614 a user based on output received as a function of a search algorithm, which may determine a fitness score for a combination of users that includes the user. In some embodiments, the fitness score describes a likelihood of success for the task by the combination of users such that the combination of users having the highest fitness score for the task is selected by the task module 206, and the method 600 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a data module that collects activity data for a user, the activity data being associated with the user's operation of a computer application;
a profile module that updates a profile for the user in response to the activity data; and
a team module that selects the user to be a member of a team based on the user's profile, the team comprising a plurality of users combined to perform a task.

2. The apparatus of claim 1, further comprising a monitor module that determines the user is actively using the computer application, the data module collecting activity data in response to the monitor module determining the computer application is actively being used.

3. The apparatus of claim 2, wherein the monitor module determines the user is actively using the computer application by detecting user input received in an active window for the computer application.

4. The apparatus of claim 1, wherein the team module selects the user for the team in response to one or more characteristics of the user's profile corresponding to one or more characteristics of the task to be performed by the team.

5. The apparatus of claim 1, wherein the team module selects the user for the team based on output received as a function of a search algorithm, the search algorithm determining a fitness score for a combination of users that includes the user, the fitness score describing a likelihood of success for the task by the combination of users, the selected combination of users having the highest fitness score for the task.

6. The apparatus of claim 1, wherein the team module recommends one or more users for the team in response to input received from a team manager, the input comprising one or more user characteristics associated with the task.

7. The apparatus of claim 1, further comprising a search module that searches one or more user profiles in response to search criteria, the search criteria comprising a plurality of search filters corresponding to the characteristics of a user profile.

8. The apparatus of claim 1, wherein the computer application comprises a multi-user computer application such that multiple users may use the computer program simultaneously, and wherein the data module collects activity data separately for each user of the multi-user computer application.

9. The apparatus of claim 1, wherein the profile for the user comprises data collected from one or more of surveys and aptitude tests.

10. The apparatus of claim 1, wherein the profile for the user comprises data received from the user, the data comprising preference data related to the user's preferences for one or more tasks.

11. The apparatus of claim 1, wherein the profile for the user comprises a plurality of characteristics associated with the user, the plurality of characteristics comprising one or more of:
computer application activity data;
demographic data;
social data;
employment data;
education data;
schedule data;
location data;
project history data; and
security clearance data.

12. The apparatus of claim 1, wherein the activity data comprises one or more of:
a total time that the computer application is used;
one or more features of the computer application that are used; and
a total time that a feature of the computer application is used.

13. A method comprising:
collecting activity data for a user, the activity data being associated with the user's operation of a computer application;
updating a profile for the user in response to the activity data; and
selecting the user to be a member of a team based on the user's profile, the team comprising a plurality of users combined to perform a task.

14. The method of claim 13, further comprising determining the user is actively using the computer application, wherein activity data is collected in response to determining the computer application is actively being used.

15. The method of claim 13, wherein determining the user is actively using the computer application comprises detecting user input received in an active window for the computer application.

16. The method of claim 13, wherein the user is selected for the team in response to one or more characteristics of the user's profile corresponding to one or more characteristics of the task to be performed by the team.

17. The method of claim 13, wherein the user is selected for the team based on output received as a function of a search algorithm, the search algorithm determining a fitness score for a combination of users that includes the user, the fitness score describing a likelihood of success for the task by the combination of users, the selected combination of users having the highest fitness score for the task.

18. The method of claim 13, further comprising recommending one or more users for the team in response to input received from a team manager, the input comprising one or more user characteristics associated with the task.

19. The method of claim 13, wherein the computer application comprises a multi-user computer application such that multiple users may use the computer program simultaneously, and wherein the activity data for each user of the multi-user computer application is collected separately.

20. A computer program product comprising a computer readable storage medium having program code embodied therein, the program code readable/executable by a processor for:
collecting activity data for a user, the activity data being associated with the user's operation of a computer application;
updating a profile for the user in response to the activity data; and
selecting the user to be a member of a team based on the user's profile, the team comprising a plurality of users combined to perform a task.
